(19) United States
(12) Patent Application Publication
(10) Pub. No.: US 2016/0006469 A1
(43) Pub. Date: Jan. 7, 2016

(54) Signaling and Procedure for In-Device Co-Existence

(71) Applicants: Wei HONG, Beijing (CN); Jari ISOKANGAS, Tampere (FI); Na WEI, Beijing (CN); Haiming WANG, Beijing (CN)

(72) Inventors: Wei HONG, Beijing (CN); Jari ISOKANGAS, Tampere (FI); Na WEI, Beijing (CN); Haiming WANG, Beijing (CN)

(73) Assignee: BROADCOM CORPORATION, Irvine, CA (US)

(21) Appl. No.: 14/400,505

(22) PCT Filed: May 11, 2012
(86) PCT No.: PCT/CN2012/075392

§ 371 Date: Nov. 11, 2014

(51) Int. Cl. H04B 1/10; H04B 1/12; H04W 76/06; H04B 1/40

(52) U.S. Cl. CPC H04B 1/1081; H04B 1/40; H04B 1/12; H04W 76/068; H04W 88/06

(57) ABSTRACT

The present invention addresses apparatuses, methods and computer program product for improvement of signaling and procedure for in-device co-existence. An IDC Resolution Timer (IRT) is added at both UE and eNB sides. The IRT starts to run once UE sends IDC indication to eNB. If UE doesn't receive any IDC response from eNB after IRT expires, UE could assume that eNB rejects its IDC indication and UE could start to use other possible methods such as switching off other ISM RAT, or using autonomous denial. If UE receive IDC response from eNB before IRT expires, it will reset the IRT.

### FIELD OF THE INVENTION

The present invention generally relates to wireless communication, and more specifically relates to techniques for handling in-device co-existence (IDC), thereby improving signaling and procedure for in-device co-existence.

### BACKGROUND

As described in [1], in order to allow users to access various networks and services ubiquitously, an increasing number of user equipments (UEs) are equipped with multiple radio transceivers. For example, a UE may be equipped with LTE™, WiFi™, and Bluetooth™ transceivers, and GNSS receivers. One resulting challenge lies in trying to avoid co-existence interference between those collocated radio transceivers. FIG. 1 shows an example of co-existence interference.

Due to extreme proximity of multiple radio transceivers within the same UE, the transmit power of one transmitter may be much higher than the received power level of another receiver. By means of filter technologies and sufficient frequency separation, the transmit signal may not result in significant interference. But for some co-existence scenarios, e.g. different radio technologies within the same UE operating on adjacent frequencies, current state-of-the-art filter technology might not provide sufficient rejection. Therefore, solving the interference problem by single generic RF design may not always be possible and alternative methods needs to be considered. There is an ongoing work item in RAN2 on this topic [1].

Also in [1], there are four proposed usage scenarios:

1a) LTE™+BT™ earphone (VoIP service)

1b) LTE™+BT™ earphone (Multimedia service)

2) LTE™+WiFi™ portable router

3) LTE™+WiFi™ offload

4) LTE™+GNSS Receiver

Also, quite a few solutions are proposed to solve this potential interference including TDM solution based on the Release-8/9/10 DRX mechanism, FDM solution, autonomous denial, etc.

There has been lots of contributions discussing about the procedure for IDC [2][3], the general idea is that UE first reports its unsolvable IDC problem to eNB whenever it has problem in ISM DL/LTE DL reception it cannot solve by itself, and then eNB could make a decision to configure TDM or FDM solution or other possible solutions to UE. UE could also use autonomous denial for ISM “rare” cases [4]. The specification doesn't specify how UE tries to solve IDC by itself.

### REFERENCES

[1] TR 36.816 v11.0.0, “Study on signalling and procedure for interference avoidance for in-device co-existence”

[2] R2-121149, “On the procedure of interference avoidance for IDC”, CMCC

[3] R2-121359, “Signalling procedure for IDC”, Huawei, HiSilicon

[4] R2-120915, Meeting report of RAN2#76.

Hence, there is still need for improvement of signaling and procedure for in-device co-existence.

### SUMMARY OF THE INVENTION

It is an object of the present invention to address the above problems. In particular, it is an object of the present invention to provide apparatuses, methods and a computer program product for improving signaling and procedure for in-device co-existence.

According to a first aspect of the present invention, there is provided a method, which comprises detecting occurrence of an in-device co-existence problem, transmitting an indication of the in-device co-existence problem occurrence to a base station, starting a timer at the time of starting the transmission, resetting the timer in case a response is received from the base station before expiry of the timer, and starting an in-device co-existence problem skirting processing in case of expiry of the timer without receiving a response from the base station.

According to a second aspect of the present invention, there is provided an apparatus, comprising at least one processor, and at least one memory including computer program code, the at least one memory and the computer program code configured to, with the at least one processor, cause the apparatus at least to perform detecting occurrence of an in-device co-existence problem, transmitting an indication of the in-device co-existence problem occurrence to a base station, starting a timer at the time of starting the transmission, resetting the timer in case a response is received from the base station before expiry of the timer, and starting an in-device co-existence problem skirting processing in case of expiry of the timer without receiving a response from the base station.

According to a third aspect of the present invention, there is provided a method, which comprises receiving an indication about occurrence of an in-device co-existence problem from a user equipment, starting a timer at the time of receiving the indication, and determining whether to transmit in-device co-existence problem solution information to the user equipment before expiry of the timer.

According to a fourth aspect of the present invention, there is provided an apparatus, comprising at least one processor, and at least one memory including computer program code, the at least one memory and the computer program code configured to, with the at least one processor, cause the apparatus at least to perform receiving an indication about occurrence of an in-device co-existence problem from a user equipment, starting a timer at the time of receiving the indication, and determining whether to transmit in-device co-existence problem solution information to the user equipment before expiry of the timer.

According to a fifth aspect of the present invention, there is provided a computer program product comprising computer-executable components which, when the program is run on a computer, are configured to carry out the method according to the first aspect and/or the method according to the third aspect.

According to a sixth aspect of the present invention, there is provided an apparatus, which comprises detection means for detecting occurrence of an in-device co-existence problem, transmission means for transmitting an indication of the in-device co-existence problem occurrence to a base station, controlling means for starting a timer at the time of starting the transmission, controlling means for resetting the timer in case a response is received from the base station before expiry of the timer, and controlling means for starting an in-device co-existence problem skirting processing in case of expiry of the timer without receiving a response from the base station.

According to a seventh aspect of the present invention, there is provided an apparatus, which comprises receiving means for receiving an indication about occurrence of an in-device co-existence problem from a user equipment, control means for starting a timer at the time of receiving the indication, and determination means for determining whether to transmit in-device co-existence problem solution information to the user equipment before expiry of the timer.

Advantageous further developments or modifications of the aforementioned exemplary aspects of the present invention are set out in the dependent claims.

### BRIEF DESCRIPTION OF DRAWINGS

For a more complete understanding of example embodiments of the present invention, reference is now made to the following descriptions taken in connection with the accompanying drawings in which:

FIG. 1 shows an example of multiple transceivers with in-device co-existence interference within one UE;

FIG. 2 shows a possible procedure for IDC as proposed in document [2];

FIG. 3 schematically illustrates a problem of the current IDC procedure;

FIG. 4 schematically shows differences among IRT, autonomous denial timer and prohibit timer;

FIG. 5 shows a situation when eNB does not responses to IDC indication timely according to certain embodiments of the present invention;

FIG. 6 shows a situation when eNB does not responses to IDC indication from UE in a first case according to certain embodiments of the present invention;

FIG. 7 shows a situation when eNB does not responses to IDC indication from UE in a second case according to certain embodiments of the present invention;

FIG. 8 shows a principle flowchart of an example for a method according to certain embodiments of the present invention, which may be implemented in a user equipment;

FIG. 9 shows a principle configuration of an example for an apparatus according to certain embodiments of the present invention;

FIG. 10 shows a principle flowchart of an example for a method according to certain embodiments of the present invention, which may be implemented in a eNB;

FIG. 11 shows a principle configuration of an example for an apparatus according to certain embodiments of the present invention;

FIG. 12 shows an exemplary IDC procedure according to certain embodiments of the present invention; and

FIG. 13 shows a further exemplary IDC procedure according to certain embodiments of the present invention

### DESCRIPTION OF EXEMPLARY EMBODIMENTS

Exemplary aspects of the present invention will be described herein below. More specifically, exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP™ specifications being used as non-limiting examples for certain exemplary network configurations and deployments. In particular, a LTE™/LTE-Advanced™ communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

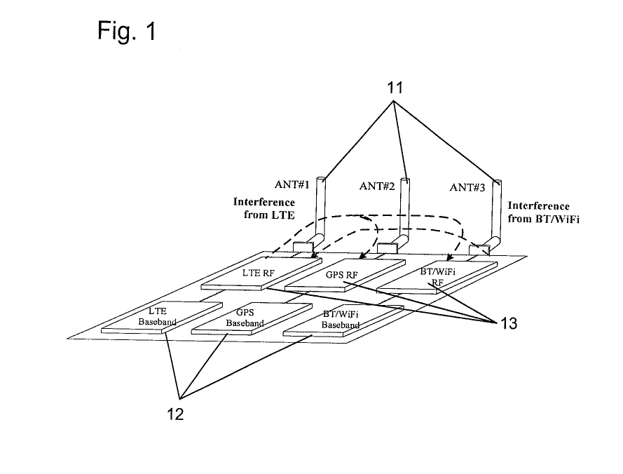

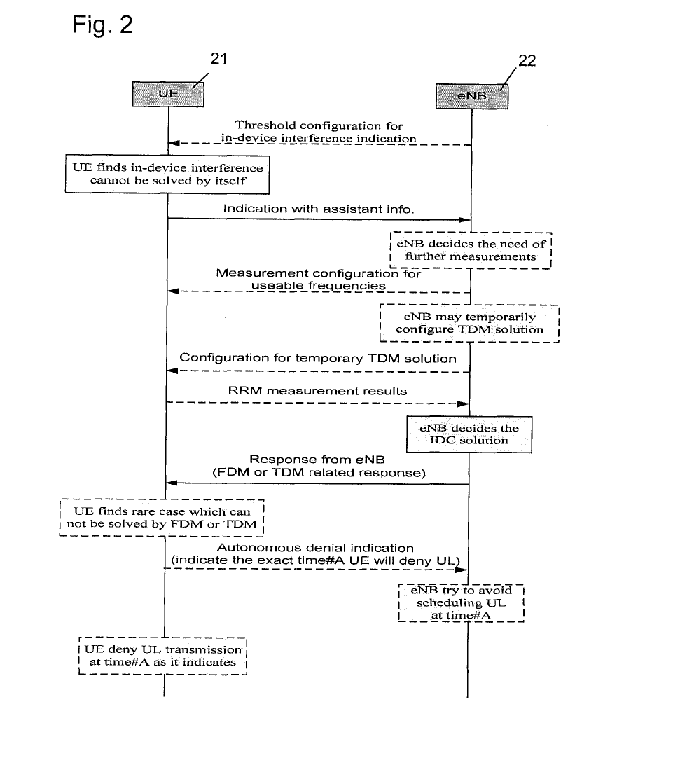

FIG. 1 shows an example of in-device co-existence interference within one UE with multiple transceivers, and FIG. 2 shows a possible procedure for IDC as proposed in document [2].

In particular, FIG. 1 shows a part of a communication device, which comprises plural baseband modules 12, such as for LTE™, GPS™ or BT™/WiFi™ communication, respective RF-modules 13 and, connected thereto, respective antennas 11. As shown in FIG. 1, interference may be occur (indicated in dashed lines), such as between LTE and BT/WiFi as an example. FIG. 2 shows signalization between an UE 21 and an eNB 22 for a possible procedure for IDC as proposed in document [2].

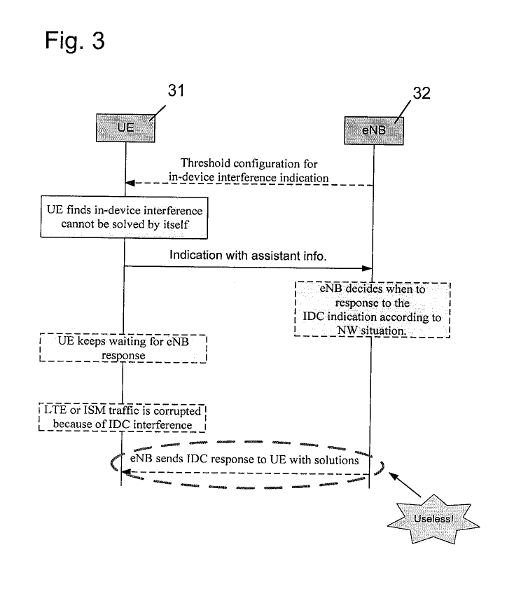

FIG. 3 schematically illustrates one example problem of the current IDC procedure. However, as indicated above, it would be beneficial to know how the user equipment (UE) could know that a serving base station, such as a eNodeB (eNB), supports IDC capability or rejects its IDC request to take next steps. Hence, if the eNB could react to UE's IDC indication at any time eNB wants, one result could be UE's LTE (Long Term Evolution) or ISM (industrial, scientific and medical band) traffic has already corrupted, then this reaction signaling is wasted, for example, as shown in FIG. 3.

That is, FIG. 3 schematically illustrates a problem of the current IDC procedure, wherein an UE 31 finds in-device interference which cannot solved by itself, and sends an indication with assistant info to a eNB 32. The eNB 32 may have transmitted a threshold configuration for in-device interference indication to the UE 31 in advance. After receiving the indication, the eNB 32 decides when to response to the IDC indication according to the network situation. In the meantime, the UE 31 keeps waiting for eNB response. There may be the instance where LTE or ISM traffic is corrupted because of IDC interference. Hence, in case the eNB 32 would send a IDC response to the UE 31 with solutions after the above instance has occurred, the transmission would be useless.

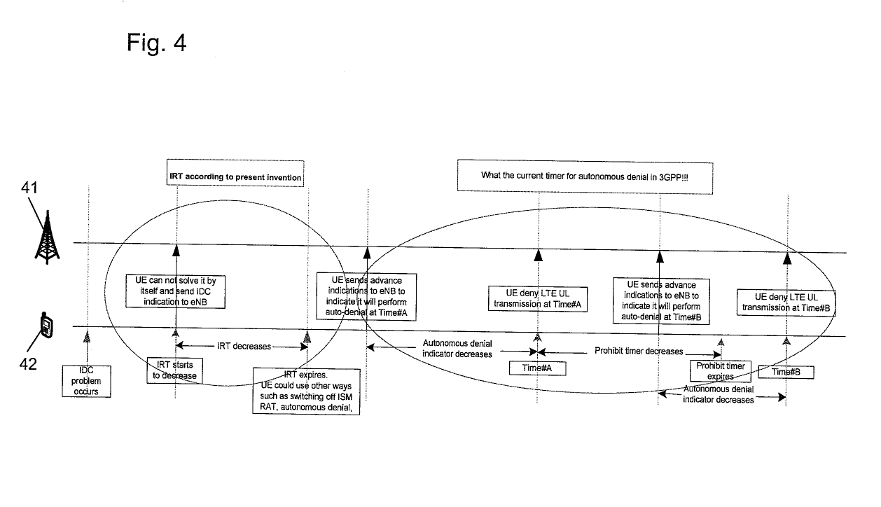

FIG. 4 shows differences among IRT, autonomous denial timer and prohibit timer handled between an UE 41 and a base station 42.

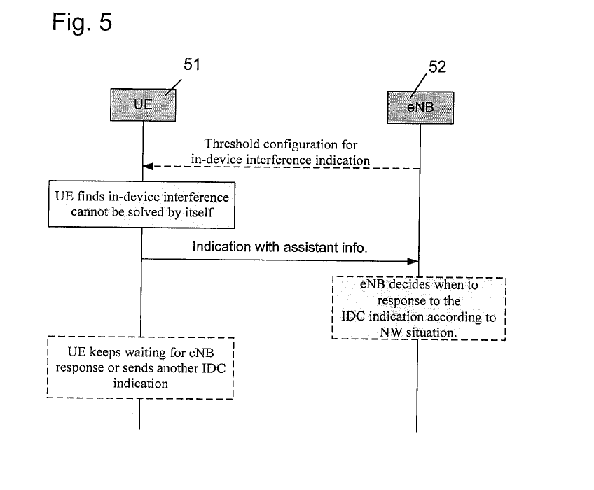

FIG. 5 shows a situation when an eNB 52 does not responses to IDC indication from a UE 51 timely. The UE 51 finds in-device interference which cannot be solved by itself, and sends an indication with assistant info to the eNB 52. The eNB 52 may have transmitted a threshold configuration for in-device interference indication to the UE 51 in advance. After receiving the indication, the eNB 52 decides when to response to the IDC indication according to the network situation. In the meantime, the UE 51 keeps waiting for eNB response.

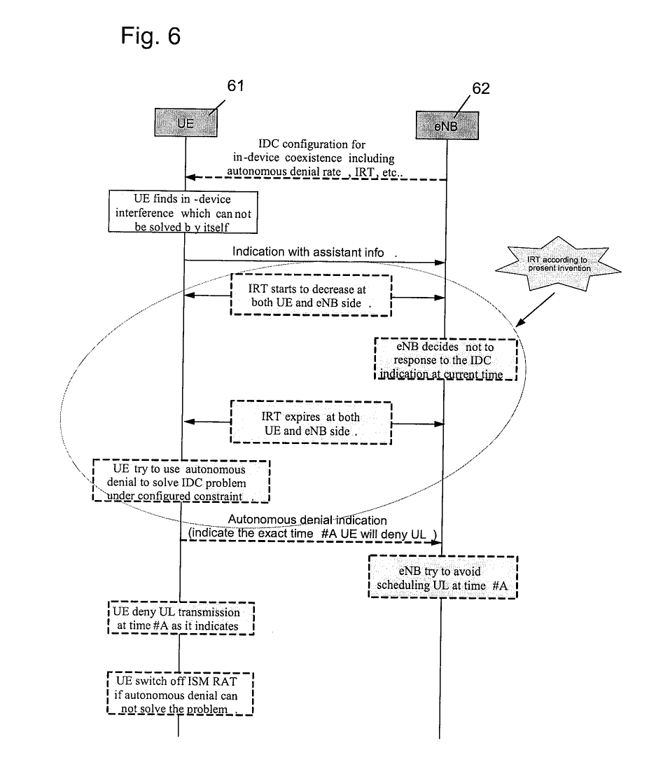

FIG. 6 shows a situation when an eNB 61 does not responses to IDC indication from a UE 62 in a first example according to certain embodiments of the present invention. The eNB 61 may send an IDC configuration for in-device coexistence including autonomous denial rate, etc. When the UE 62 finds an in-device interference which cannot be solved by itself, an indication with assist info is transmitted to the eNB 61. At that time, at both UE 61 and eNB 62 side IRT starts to decrease. Thereby, the eNB 61 may decide not to respond to the IDC indication at current time. When the IRT expires at both UE 62 and eNB 61 side, the UE 62 may try to use autonomous denial to solve IDC problem under configured constraint. Thereafter, an autonomous denial indication, which indicates the exact time #A UE will deny uplink (UL), may be transmitted from the UE 62 to the eNB 61. With this information, the eNB 61 may try to avoid scheduling UL at time #A as an example, whereas the UE 62 denies transmission at time #A as it indicates. Thereafter, the UE may switch off e.g. ISM RAT if autonomous denial cannot solve the problem.

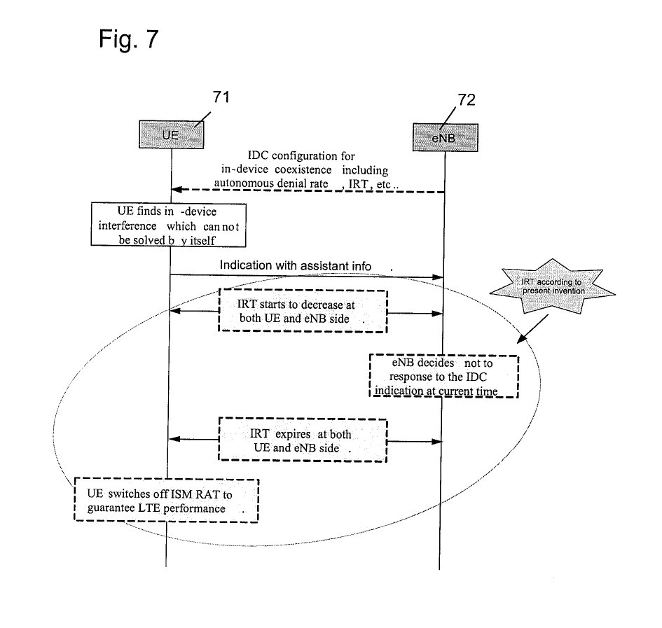

According to FIG. 7, a situation is shown, when an eNB 71 does not responses to IDC indication from a UE 72 in a second example according to certain embodiments of the present invention. The eNB 71 may send an IDC configuration for in-device coexistence including autonomous denial rate, IRT, etc. When the UE 72 finds an in-device interference which cannot be solved by itself, an indication with assist info is transmitted to the eNB 71. At that time, at both UE 71 and eNB 72 side IRT starts to decrease. Thereby, the eNB 71 may decide not to respond to the IDC indication at current time. When the IRT expires at both UE 72 and eNB 71 side, the UE 72 may try to switch off e.g. ISM RAT to guarantee LTE performance.

Another thing is, currently IDC end indication is discussed to be used after eNB configures TDM/FDM (time division multiplex/frequency division multiplex) solution and it could tell eNB when to stop the TDM pattern to enhance efficiency.

According to the present invention, as one example, an IDC Resolution Timer (IRT) is added at both UE and eNB sides. The IRT starts to run once UE sends IDC indication to eNB. If UE doesn't receive any IDC response from eNB after IRT expires, UE could assume that eNB rejects its IDC indication and UE could start to use other possible methods such as switching off other ISM RAT, or using autonomous denial. If UE receives IDC response from eNB before IRT expires, it will reset and/or stop the IRT.

If without using the IDC resolution timer (IRT) according to the present invention, it might be helpful that UE sends an IDC end indication to the eNB after the IDC vanished in case the UE sent the IDC indication to the eNB before and the eNB didn't send response. That is, for example, at Time#A, UE sends IDC indication to eNB but eNB doesn't response. At Time#(A+B), the IDC problem vanished by itself, then UE sends an IDC end indication. However, if using the IRT according to some embodiments there is no need for UE to send IDC end indication to the eNB after the IDC vanished in case the UE sent the IDC indication to the eNB before and eNB didn't send a solution. That is, for example, at Time#C, UE sends IDC indication to eNB but eNB doesn't send a solution until IRT expires. At Time#(C+D), the IDC problem vanished by itself, however, there is no need that UE sends an IDC end indication. So this signaling is also saved. Hence, some embodiments of the present invention may save unnecessary radio resource control (RRC) signaling, for example.

According to RAN2#77bis agreement, the IDC indication can also be reused to send the updated assistant information (including the case that there is no longer an IDC problem), but how to indicate this in the IDC indication is unvalued, so as to learn about the behavior of UE about performing autonomous denial when serving eNB doesn't support IDC capability.

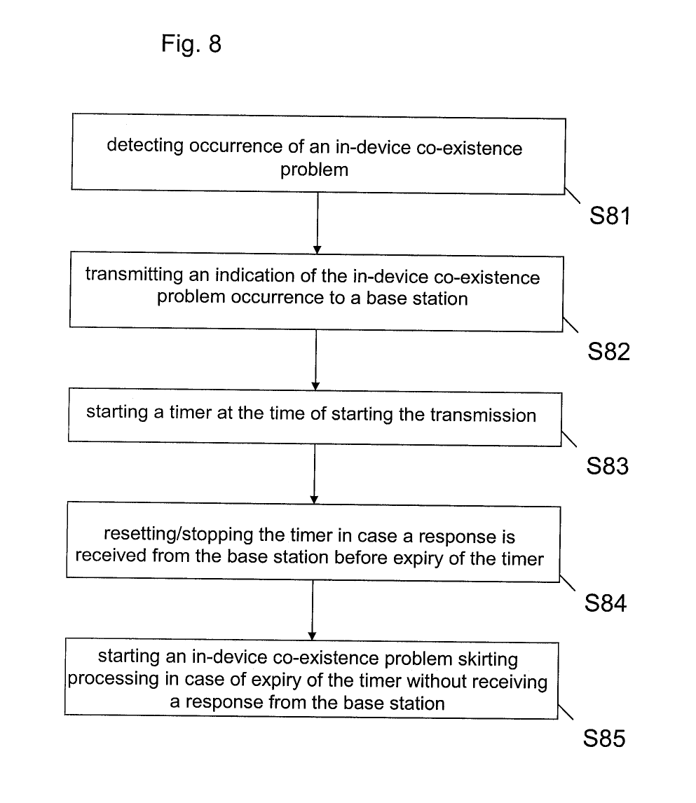

FIG. 8 shows a principle flowchart of an example for a method according to certain embodiments of the present invention.

In Step S81, occurrence of an in-device co-existence problem, such as an in-device interference, is detected.

In Step S82, an indication of the in-device co-existence problem occurrence is transmitted to a base station.

In Step S83, a timer is started at the time of starting the transmission.

In Step S84, the timer is reset and/or stopped in case a response is received from the base station before expiry of the timer.

In Step S85, an in-device co-existence problem skirting processing is started in case of expiry of the timer without receiving a response from the base station.

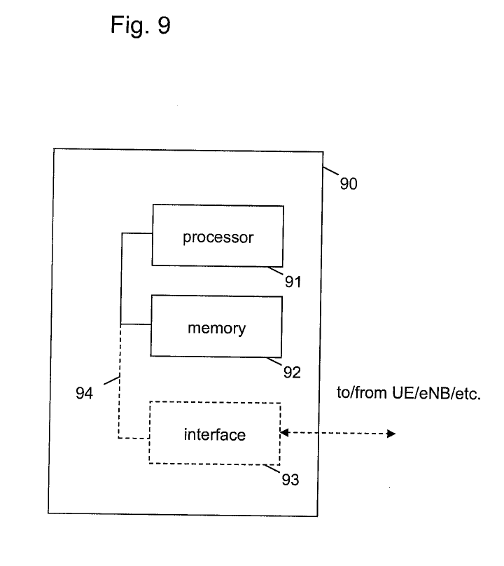

FIG. 9 shows a principle configuration of an example for an apparatus according to certain embodiments of the present invention. The apparatus 90 comprises at least one processor 91 and at least one memory 92 including computer program code, which are connected by a bus 94 or the like. As indicated with a dashed line in FIG. 9, an interface 93 may optionally be connected to the bus 94 or the like, which may enable communication e.g. to/from a network entity, a base station, a UE, or the like. The at least one memory and the computer program code are arranged to, with the at least one processor, cause the apparatus at least to perform detecting occurrence of an in-device co-existence problem, transmitting an indication of the in-device co-existence problem occurrence to a base station, starting a timer at the time of starting the transmission, resetting and/or stopping the timer in case a response is received from the base station before expiry of the timer, and starting an in-device co-existence problem skirting processing in case of expiry of the timer without receiving a response from the base station.

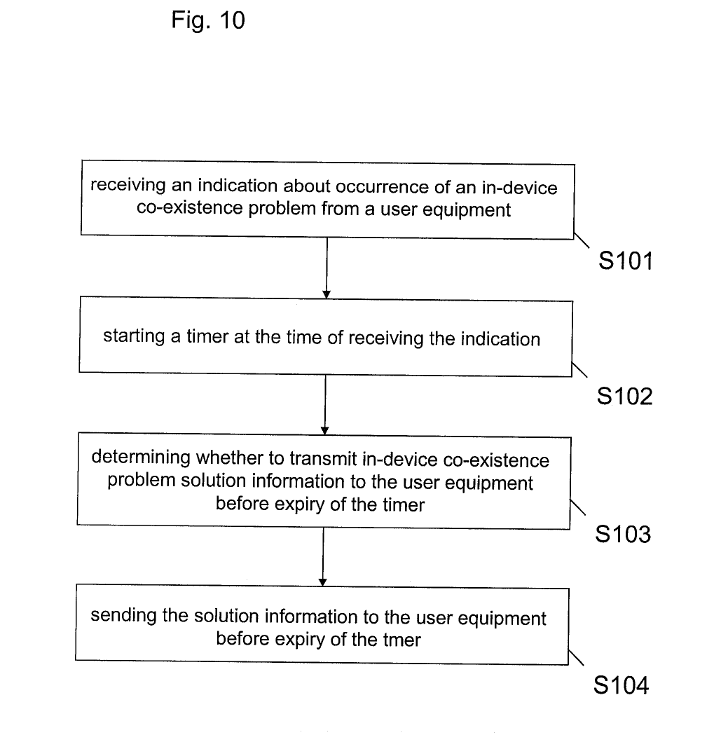

FIG. 10 shows a principle flowchart of an example for a method according to certain embodiments of the present invention.

In Step S101, an indication about occurrence of an in-device co-existence problem is received from a user equipment.

In Step S102, a timer is started at the time of receiving the indication.

In Step S103, it is determined, whether to transmit in-device co-existence problem solution information to the user equipment before expiry of the timer. In some embodiments, at least one request may be sent to the user equipment for further information before sending any solution information.

In Step S104, the solution information may be sent to the user equipment before expiry of the timer.

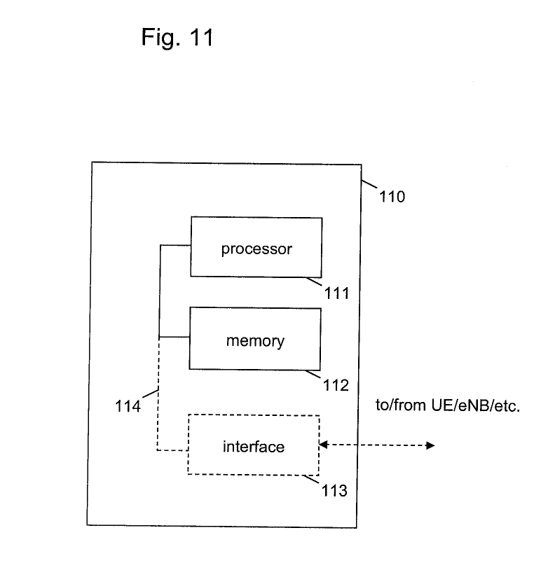

FIG. 11 shows a principle configuration of an example for an apparatus according to certain embodiments of the present invention. The apparatus 110 comprises at least one processor 111 and at least one memory 112 including computer program code, which are connected by a bus 114 or the like. As indicated with a dashed line in FIG. 11, an interface 113 may optionally be connected to the bus 114 or the like, which may enable communication e.g. to/from a user equipment, a network entity, a base station, or the like. The at least one memory and the computer program code are arranged to, with the at least one processor, cause the apparatus at least to perform receiving an indication about occurrence of an in-device co-existence problem from a user equipment, starting a timer at the time of receiving the indication, and determining whether to transmit in-device co-existence problem solution information to the user equipment before expiry of the timer.

According to certain embodiments of the present invention, in order to solve the problems mentioned above and make the IDC procedure completed, the following features are noted:
1. A timer, which is called an IDC Resolution Timer (IRT) for example, is proposed at both UE and eNB sides. The IRT starts to run once UE sends IDC indication to eNB. If the UE doesn't receive any IDC response from the eNB after the IRT expires, UE could assume that the eNB rejects its IDC indication and UE could start to use other possible methods such as switching off other ISM RAT, or using autonomous denial. If UE receive IDC response from eNB before IRT expires, it will reset the IRT.
   The IRT is used in both eNB and UE sides to let eNB decide to send IDC response or not based on the network situation, and it may not the processing time that eNB receives IDC indication from UE.
2. There could be default IRT value at first and UE could suggest an IRT value to eNB according to its victim module's QoS (Quality of Service) so that within IRT, the victim module's traffic will not corrupt. In some embodiments, his recommended IRT value could be included in the IDC indication. In some embodiments, a timestamp may be added to tell eNB when the UE sends the IDC indication containing the IRT value. As example, the module which is facing IDC interference is the one receiving signal. It is interfered by UE's another module which is transmitting signal.
3. A new IDC end Signaling (IES) is proposed to let UE tell eNB that IDC problem is over so that eNB could terminate the TDM pattern or update the unusable frequency list to enhance efficiency. In some embodiments, the new signaling could be a new medium access control-control element (MAC CE), a new RRC signaling or a new fast Level 1 (L1) signaling. It may also be included in the IDC indication signaling to update the end of IDC problem.
   a. One way could be adding a detailed IE into IDC indication to indicate the end of IDC problem,
   b. Another way could be to re-interpret existing bits in the new IDC indication RRC signaling such as setting the TDM pattern as 0s and/or setting the unusable FDM pattern as 0s.
4. A new IE is proposed to be included, for example, in RRCConnectionReconfiguration, which could configure IDC related parameters such as IRT value and/or autonomous denial limit.
5. A new IE is proposed to be included, for example, in the new SystemInformationBlockType14 (SIB14) which is used to contain IDC related parameters to express certain parameters such as autonomous denial limits, IRT, and so on.
6. Rule#1: The eNB could configure the new IE proposed in invention point#2 to 3GPP-Release 11 (R11) UE once the R11 UE accesses to the eNB so that the R11 UE could know that this eNB support IDC. If this IE is not configured, UE could know that this eNB doesn't support IDC.
7. Rule#2: The UE couldn't perform autonomous denial if the serving eNB doesn't support IDC capability or the UE could perform autonomous denial only under certain rules even if eNB doesn't support IDC capability. The rule could be that UE could maintain a reasonable denial rate which is lower than the rate with eNB supporting IDC to ensure the performance loss is under a certain ratio.

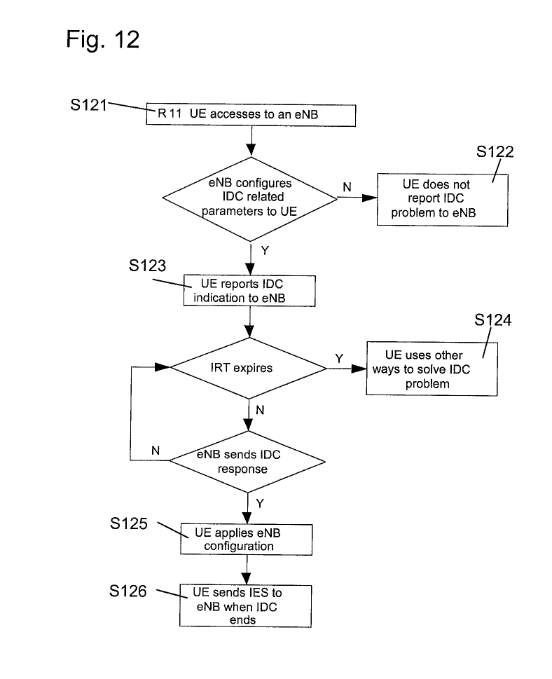

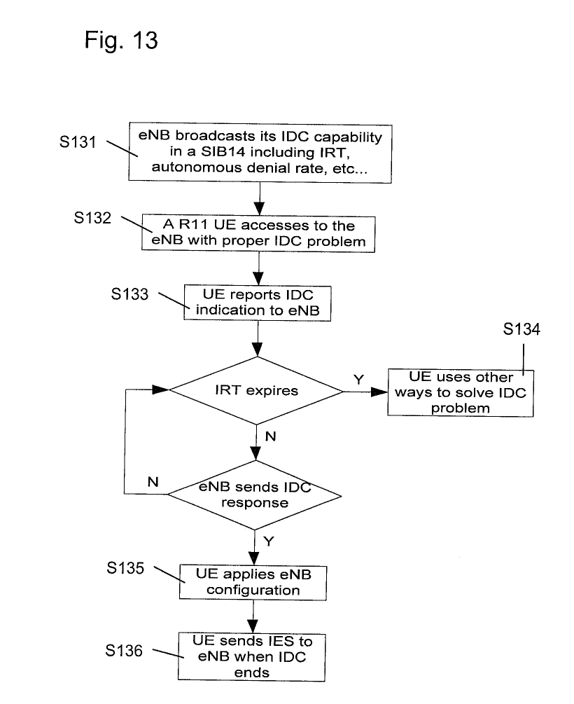

The exemplary implementations under Rule#1 and Rule#2 are described in FIGS. 12 and 13.

FIG. 12 shows an example of IDC procedure under Rule#1, and FIG. 13 shows an example of IDC procedure under Rule#2. According to FIG. 12, in S121, a Release 11 compatible UE accesses to an eNB. When the eNB configures IDC related parameters to the UE, the UE reports IDC indication to eNB in S123. If not, the UE does not report IDC problem to the eNB.

After having reported in S123, it is determined whether the IRT expires. In case the IRT expires, the UE uses other ways to solve IDC problem in S124. When the IRT has not expired yet, it is determined whether the eNB sends IDC response. When the eNB does not send IDC response, it is returned to determine whether the IRT expires. Otherwise, when the eNB sends IDC response, the UE applies eNB configuration in S125. In S126, the UE sends IES to eNB when IDC ends.

In FIG. 13, eNB broadcasts its IDC capability in a new SIB14 including the value of IRT, the value of autonomous denial limits and so on, so that UE will know that the serving eNB supports IDC capability. Then UE will send IDC indication to eNB with recommended IRT value once it can't solve the IDC problem by itself. Once UE receives IDC response from eNB within IDC Resolution Timer, it could apply eNB's configuration. When the IDC problem ends, UE will send IDC End Signaling to eNB to tell eNB the IDC problem is over. So eNB could stop the TDM pattern or use the previous unusable frequencies.

In particular, according to FIG. 13, in S131, the eNB broadcasts its IDC capability in a SIB14 including IRT, autonomous denial rate, etc. In S132, a Release 11 compatible UE accesses to the eNB with proper IDC problem. In S133, the UE reports IDC indication to eNB. After having reported in S133, it is determined whether the IRT expires. In case the IRT expires, the UE uses other ways to solve IDC problem in S134. When the IRT has not expired yet, it is determined whether the eNB sends IDC response. When the eNB does not send IDC response, it is returned to determine whether the IRT expires. Otherwise, when the eNB sends IDC response, the UE applies eNB configuration in S135. In S136, the UE sends IES to eNB when IDC ends.

The IE SystemInformationBlockType14 as depicted below contains the information related to IDC parameters:

SystemInformationBlockType14 information element:

| -- ASN1START | | |
|---|---|---|
| SystemInformationBlockType14-r11 ::= | | SEQUENCE { |
| | idcResolutionTimer ::= | ENUMERATED { |

sf50, Sf75, sf100, infinity}

| | |
|---|---|
| autonomousDenialLimit ::= | INTEGER (0..31) |
| ... | |

}
-- ASN1STOP

Among others, examples of the advantages of the some embodiments are:

(1) UE will know which eNB have what kinds of IDC capability to avoid unnecessary IDC reporting.

(2) UE will know which eNB have what kinds of IDC capability to avoid unnecessary autonomous denial impacting system performance heavily.

(3) There will be no ambiguity period for eNB and UE.

(4) UE/eNB could save unnecessary RRC signaling in case eNB couldn't provide TDM/FDM solution.

Embodiments of the invention are described based on an LTE-A system but embodiments of the invention may be applied to other radio access technologies such as LTE, WiFi, WLAN, UMTS, HSPA, if in-device co-existence indicating is foreseen.

A device may be a user equipment, a terminal, a mobile phone, a laptop, a smartphone, a tablet PC, or any other device that may attach to the mobile network. A base station may be a NodeB, an eNodeB or any other base station of a radio network.

If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a controller apparatus such as a user equipment, a UE, or a component thereof, an apparatus embodying the same, a method for controlling and/or operating the same, and computer program(s) controlling and/or operating the same as well as mediums carrying such computer progrann(s) and forming computer program product(s). Furthermore, it should thus be apparent that exemplary embodiments of the present invention provide, for example a base station apparatus such as a NodeB or an eNodeB, or a component thereof, an apparatus embodying the same, a method for controlling and/or operating the same, and computer program(s) controlling and/or operating the same as well as mediums carrying such computer program(s) and forming computer program product(s).

According to exemplarily embodiments of the present invention, a system may comprise any conceivable combination of the thus depicted devices/apparatuses and other network elements, which are configured to cooperate with any one of them.

In general, it is to be noted that respective functional blocks or elements according to above-described aspects can be implemented by any known means, either in hardware and/or software/firmware, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processor or other circuitry may refer to one or more of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software/firmware or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

### LIST OF ABBREVIATIONS

CC Component Carrier

PDCCH Physical Dedicated Control Channel

DL Downlink

eNB Enhanced NodeB

LTE Long Term Evolution

LTE-A Long Term Evolution Advanced

UE User Equipment

UL Uplink

IDC in-device co-existence

IRT IDC resolution timer

BT Bluetooth

GPS Global Positioning System

ISM Industrial, scientific and medical band

MAC Medium Access Control

CE control element

IP Internet protocol

GNSS Global Navigation Satellite System

RF Radio Frequency

UTRAN Universal terrestrial radio access network

E-UTRAN Enhanced UTRAN

TX Transmit

RX Receive

3GPP Third generation partnership project

TS Technical Specification

RRC Radio resource control

MAC Medium access control

RAN Radio access network

RAT Radio access technology

TDM Time Division Multiplex

FDM Frequency Division Multiplex

IE Information Element

L1 Level 1

1. A method, comprising:
detecting occurrence of an in-device co-existence problem;
transmitting an indication of the in-device co-existence problem occurrence to a base station;
starting a timer at the time of starting the transmission ;
resetting and/or stopping the timer in case a response is received from the base station before expiry of the timer; and
starting an in-device co-existence problem skirting processing in case of expiry of the timer without receiving a response from the base station.

2. The method according to claim 1, wherein the in-device co-existence problem skirting processing is using autonomous denial, in which an indication about autonomous denial indicating the time at which reception of an uplink transmission is denied is transmitted to the base station, and reception of the uplink transmission is denied at the indicated time.

3-12. (canceled)

13. An apparatus, comprising
at least one processor; and
at least one memory including computer program code;
the at least one memory and the computer program code configured to, with the at least one processor, cause the apparatus at least to perform:
detecting occurrence of an in-device co-existence problem;
transmitting an indication of the in-device co-existence problem occurrence to a base station;
starting a timer at the time of starting the transmission;
resetting and/or stopping the timer in case a response is received from the base station before expiry of the timer; and
starting an in-device co-existence problem skirting processing in case of expiry of the timer without receiving a response from the base station.

14. The apparatus according to claim 13, wherein the in-device co-existence problem skirting processing is using autonomous denial, in which an indication about autonomous denial indicating the time at which reception of an uplink transmission is denied is transmitted to the base station, and reception of the uplink transmission is denied at the indicated time.

15. The apparatus according to claim 13, wherein the in-device co-existence problem skirting processing is switching of interfering radio access technology.

16. (canceled)

17. The apparatus according to claim 13, wherein the at least one memory and the computer program code, with the at least one processor further cause the apparatus at least to perform receiving in-device co-existence configuration information from the base station, wherein, when it is detected that the base station does not provide in-device co-existence configuration, prohibiting transmission of the indication of the in-device co-existence problem occurrence to the base station.

18. (canceled)

19. The apparatus according to claim 13, wherein the at least one memory and the computer program code, with the at least one processor further cause the apparatus at least to perform transmitting an end signaling to the base station, in case it is detected that occurrence of the in-device co-existence problem has ended.

20. The apparatus according to claim 19, wherein the end signaling is included in the in-device co-existence indication signaling as a new information element or re-interpretation of the existing bits of the in-device co-existence indication signaling.

21. The apparatus according to claim 13, wherein a value from start to expiry of the timer is a preset value.

22. The apparatus according to claim 13, wherein a value from start to expiry of the timer is a default timer value that is updated according to the Quality of Service of traffic.

23-25. (canceled)

26. The apparatus according to claim 13, wherein the apparatus is comprised in an user equipment.

27-35. (canceled)

36. An apparatus, comprising:
at least one processor; and
at least one memory including computer program code;
the at least one memory and the computer program code configured to, with the at least one processor, cause the apparatus at least to perform:
receiving an indication about occurrence of an in-device co-existence problem from a user equipment;
starting a timer at the time of receiving the indication; and
determining whether to transmit in-device co-existence problem solution information to the user equipment before expiry of the timer.

37. The apparatus according to claim 36, further comprising transmitting in-device co-existence configuration information to the user equipment, wherein the in-device co-existence configuration information is broadcasted.

38. The apparatus according to claim 36, wherein the apparatus includes an in-device co-existence resolution timer with timestamp.

39-40. (canceled)

41. The apparatus according to claim 36, wherein a value from start to expiry of the timer is a preset value.

42. The apparatus according to claim 36, wherein a value from start to expiry of the timer is a default timer value that is updated according to the Quality of Service of user equipment's different traffic.

43. The apparatus according to claim 37, wherein a value from start to expiry of the timer is included in the in-device co-existence configuration information.

44. The apparatus according to claim 38, wherein a value from start to expiry of the timer is included in the in-device co-existence indication signaling sent by user equipment with timestamp.

45. The apparatus according to claim 36, wherein the apparatus belongs to a long-term evolution system or a long-term evolution advanced system.

46. The apparatus according to claim 36, wherein the apparatus is comprised in a base station.

47-51. (canceled)
